(19) United States
(12) Patent Application Publication
(10) Pub. No.: US 2012/0044528 A1
(43) Pub. Date: Feb. 23, 2012

(54) Material Printing System for Distributing Updated Meeting Material to Participants

(75) Inventors: Yoshiaki Shibuta, Amagasaki-shi (JP); Tomoyuki Okamoto, Kyoto-shi (JP); Yasuji Takeuchi, Kobe-shi (JP); Nobuo Kamei, Osaka-shi (JP); Tomo Tsuboi, Itami-shi (JP)

(73) Assignee: Konica Minolta Business Technologies, Inc., Chiyoda-ku (JP)

(21) Appl. No.: 13/193,807

(22) Filed: Jul. 29, 2011

(30) Foreign Application Priority Data
Aug. 19, 2010 (JP) 2010-184235

(51) Int. Cl. G06K 15/02

(52) U.S. Cl. 358/1.15

(57) ABSTRACT

A material printing system includes a reference setting unit for setting any given version of material data as reference material data, among plural versions of material data concerning a particular meeting, in accordance with a user's instruction, a printing history search unit for obtaining a printing history of material data concerning the particular meeting for a participant in the particular meeting, and an operation unit for calculating the difference between material data printed by a participant in the particular meeting and the reference material data concerning the particular meeting, and a printing unit for printing differential data corresponding to the difference.

This application is based on Japanese Patent Application No. 2010-184235 filed with the Japan Patent Office on Aug. 19, 2010, the entire content of which is hereby incorporated by reference.

### BACKGROUND OF THE INVENTION

1. Field of the Invention

The present invention relates to a material printing system, and more particularly to a material printing system for distributing updated meeting materials to participants.

2. Description of the Background Art

In meetings, organizers often distribute materials to be used in meetings to participants (prospective participants) beforehand in order to notify them of the contents of the meetings. Even when the materials are electronically created, the participants tend to obtain the materials printed on a recording medium such as paper in order to easily taking notes and viewing the materials.

However, a material creator often updates a material once after distributing the material to participants, for example, because the material includes fluid contents. In such a case, the participants may attend the meeting without noticing that the material has been updated, or the participants cannot obtain the updated material, for example, because their PCs are not connected to a network. As a result, in the actual meeting, the versions of the material held by the participants may differ from each other.

Then, a technique has been devised in which when a meeting material to be distributed is updated, participants are notified that the material is updated. According to another technique, whether participants have printed a material is determined when the participants enter a meeting room, and if not printed, the materials is printed. A technique is also devised to specify which participant should print which material in an event and to prompt the participant to print the material.

For example, Document 1 below discloses a multifunction peripheral including a document management device. The multifunction peripheral includes a history management unit that obtains a version of meeting material data and records, in a print history, that a user corresponding to identification information has printed the obtained version of meeting material data, an information management unit that updates the meeting material data to new meeting material data and updates the version of the meeting material data, and an information notification unit that refers to the print history to recognize the identification information wherein the previous version of meeting material data has been printed, and gives a notification that the meeting material data has been updated, based on destination information corresponding to the recognized identification information. The multifunction peripheral automatically obtains information of a page of the meeting material that is required for each user name (the unprinted page of the meeting material), for the latest version of meeting material data, and prints the page of the meeting material that is required for each user name, based on the obtained information.
Document 1: Japanese Laid-Open Patent Publication No. 2007-207049

However, the meeting material data having the latest creation date and time is not always formal meeting material data (that is, meeting material data actually used in a meeting). A material creator may revise a meeting material and create a new version of meeting material data but in the end use an old version of meeting material data before revision as formal meeting material data. In this case, the multifunction peripheral in Document 1 is inconvenient in that the formal meeting material data cannot be distributed to participants.

### SUMMARY OF THE INVENTION

An object of the present invention is to provide a convenient material printing system responsive to actual meeting materials.

A material printing system according to an aspect of the present invention includes: a first reference setting unit for setting any given version of material data as reference material data, among plural versions of material data concerning a particular meeting, in accordance with an instruction from a user; a history obtaining unit for obtaining a printing history of material data concerning the particular meeting for a participant in the particular meeting; a calculation unit for calculating a difference between material data printed by a participant in the particular meeting and the reference material data concerning the particular meeting, based on the printing history obtained by the history obtaining unit; and a printing unit for printing differential data corresponding to the difference.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a configuration of a material printing system in an embodiment of the present invention.

FIG. 2 is a diagram conceptually showing conversion of data formats when printing is done.

FIG. 3 is a conceptual diagram showing the relation between a material created by a meeting organizer and printing data corresponding to the material.

FIG. 4 is a block diagram functionally showing a configuration of an MFP 110 in the embodiment of the present invention.

FIG. 5 shows an exemplary meeting information table stored in an HDD 101 of an MFP 110a.

FIG. 6 shows an exemplary print information table stored in HDD 101 of MFP 110a.

FIG. 7 shows exemplary printing history data stored in HDD 101 of MFP 110.

FIG. 8 shows an exemplary ID information table stored in HDD 101 of MFP 110.

FIG. 9 shows an exemplary printing dialog box appearing on a display unit 196 of a PC 190a when reference material data is set.

FIG. 10 is a flowchart showing a material data printing process and a reference material data setting process executed by a control unit 130 of MFP 110a in the embodiment of the present invention.

FIG. 11 shows an exemplary dialog box appearing on a display unit of a PC of a meeting organizer in step S111 in FIG. 10.

FIG. 12 shows an exemplary dialog box appearing on a display unit of a PC of a meeting participant in step S106 in FIG. 10.

FIG. 13 is a flowchart of a print data printing process executed by control unit 130 of MFP 110a.

FIG. 14 shows an exemplary warning dialog box appearing in step S133 in FIG. 13.

FIG. 15 shows an exemplary screen appearing on an operation panel unit 154 of MFP 110 when a meeting organizer is going to print a material to be distributed to meeting participants.

FIG. 16 is a flowchart showing a differential printing process executed by control unit 130 of MFP 110a in the embodiment of the present invention.

FIG. 17 shows an exemplary meeting material in which printing data is printed.

FIG. 18 shows exemplary display of display unit 196 of PC 190a when a notification of a participant having a difference detected is given in step S17 in FIG. 16.

FIG. 19 is the first half of a flowchart showing a modification of the differential printing process executed by control unit 130 of MFP 110a in the embodiment of the present invention.

FIG. 20 is the second half of the flowchart showing a modification of the differential printing process executed by control unit 130 of MFP 110a in the embodiment of the present invention.

### DESCRIPTION OF THE PREFERRED EMBODIMENTS

In the following, an embodiment of the present invention will be described based on the figures.

### [Configuration of Material Printing System]

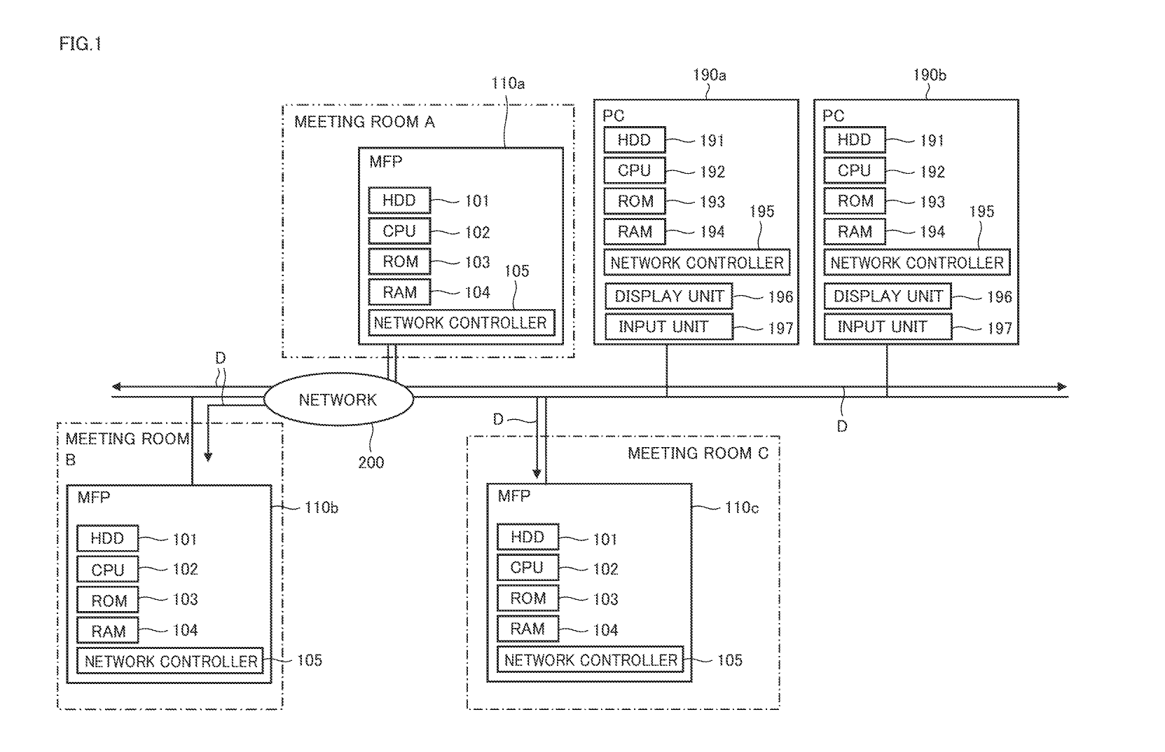

Referring to FIG. 1, a material printing system in the present embodiment includes, for example, MFPs (Multi Function Peripherals) (an example of the material printing apparatus) 110a, 110b, 110c (MFP 110a, 110b, 110c may also be collectively called MFP 110 hereinafter), and PCs 190a and 190b (PCs 190a and 190b may also be collectively called PC 190 hereinafter). A plurality of MFPs 110 are connected with each other via a network 200. Each of MFPs 110 are connected with each of PCs 190 via a network 200. MFP 110a is installed, for example, in a meeting room A, MFP 110b is installed, for example, in a meeting room B, and MFP 110c is installed, for example, in a meeting room C.

MFP 110 includes a scanner function, a facsimile function, a copy function, a printer function, a data communication function, and a server function. In particular, when the printer function is used, a meeting material can be output in the form of a paper printout. MFP 110 includes an HDD (Hard Disk Drive) 101, a CPU (Central Processing Unit) 102, a ROM (Read Only Memory) 103, a RAM (Random Access Memory) 104, and a network controller 105.

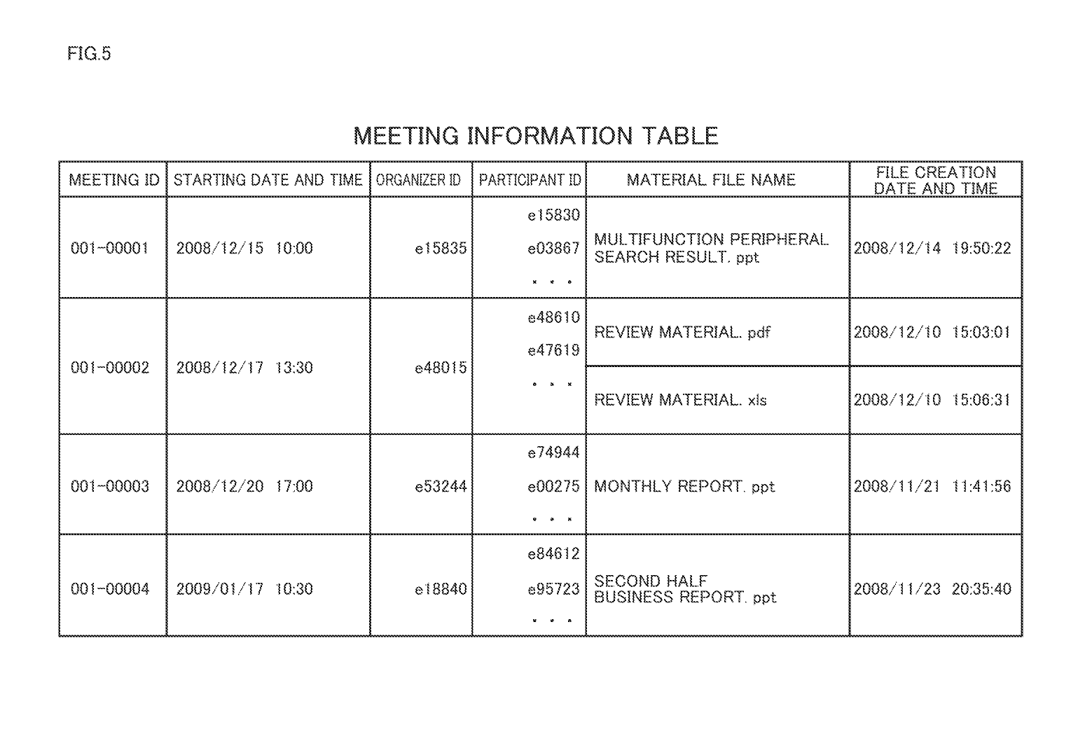

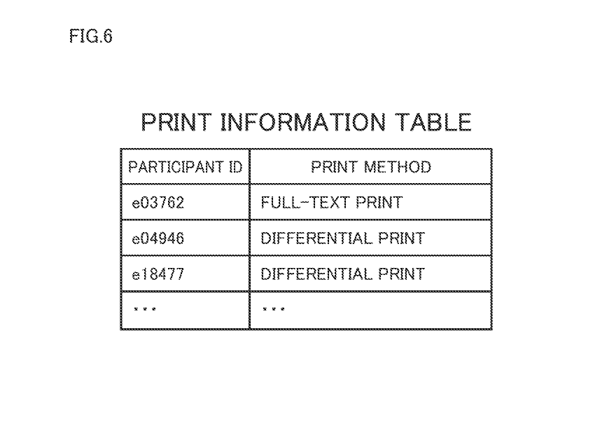

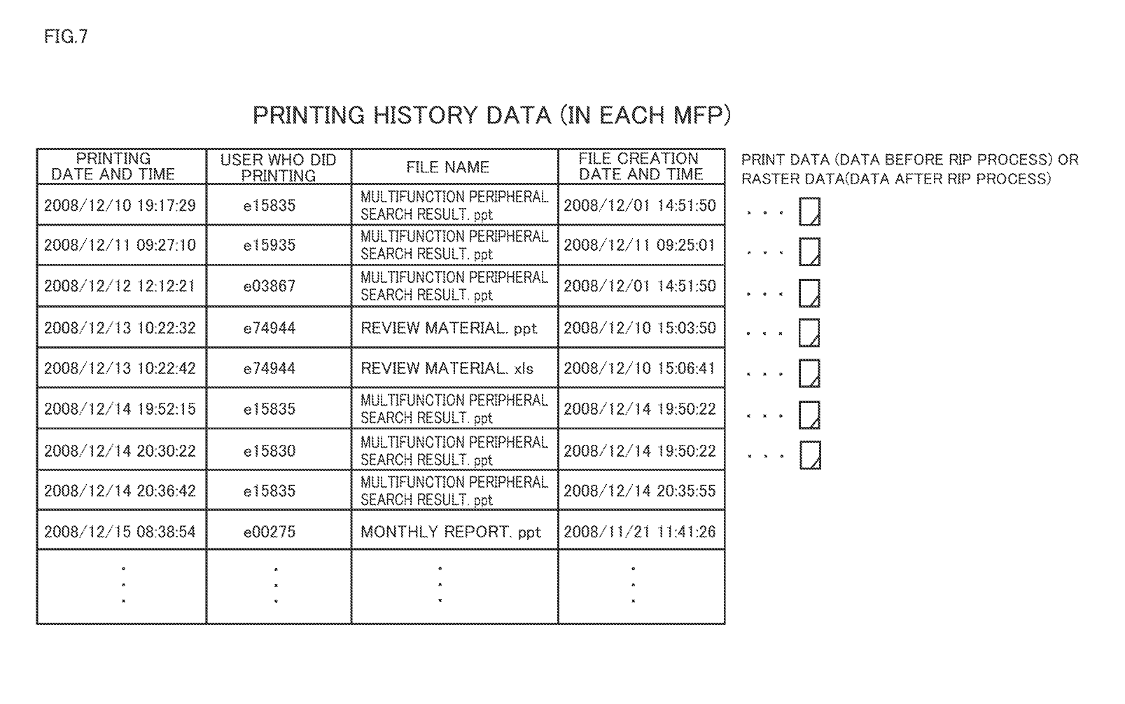

HDD 101 stores data such as printing data externally sent through network controller 105 (for example, print data in PDL (Page Description Language)) and image data scanned by a scanner unit. HDD 101 also stores a meeting information table (FIG. 5) and a print information table (FIG. 6) as described later. HDD 101 further stores printing history data (FIG. 7) in the given MFP and an ID information table (FIG. 8). HDD 101 may store raster data after an RIP (raster image processing) process, in place of PDL print data (or in addition to PDL print data).

CPU 102 performs control of the entire MFP 110, such as a scan job, a copy job, and a print job. CPU 102 reads data from ROM 103 or writes data into ROM 103 through prescribed processing.

ROM 103 is, for example, a flash ROM (Flash Memory). ROM 103 stores a variety of programs for performing operations of MFP 110, including a program for a material printing process, and a variety of fixed data. ROM 103 may be non-rewritable.

RAM 104 is a main memory of CPU 102. RAM 104 is used to store data required when CPU 102 executes a control program.

Network controller 105 communicates with an external device such as any other MFP 110 or PC 190, for example, via a LAN using a communication protocol such as TCP/IP in accordance with an instruction from CPU 102.

PC 190a is, for example, a terminal device for a meeting organizer (or a material creator) and is used to create a material or meeting information to be used in a meeting. PC 190b is, for example, a terminal device for a meeting participant and is used by the meeting participant to give MFP 110 an instruction to print a material to be used in a meeting or to view a material to be used in a meeting.

A user who serves as a meeting organizer can access HDD 101 of MFP 110a using PC 190a to create or view meeting information in the meeting information table. CPU 102 of MFP 110a may perform user authentication with password entry, a request for an ID card, or any other methods, and permits only the authenticated user to create or view the meeting information in the meeting information table.

PC 190 includes an HDD 191, a CPU 192, a ROM 193, a RAM 194, a network controller 195, a display unit 196 such as a monitor, and an input unit 197 such as a keyboard and a mouse. PC 190 contains application software in its storage for creating documents and graphics. In place of PC 190, a workstation, a portable information terminal, or a mobile phone terminal, for example, may be used as a terminal device for a meeting organizer.

Network 200 is a wired or wireless LAN (Local Area Network). Network 200 is connected using a protocol such as TCP/IP (Transmission Control Protocol/Internet Protocol). Devices connected to network 200 can mutually exchange a variety of data. Devices may be connected using a wide area network such as the Internet or a private line, in place of network 200.

In the present embodiment, an MFP, which is one of image forming apparatuses, is shown as a material printing apparatus. However, the material printing apparatus in the present invention may be any other image forming apparatus such as a facsimile machine, a copier, or a printer.

### [Conversion of Data Format in Printing]

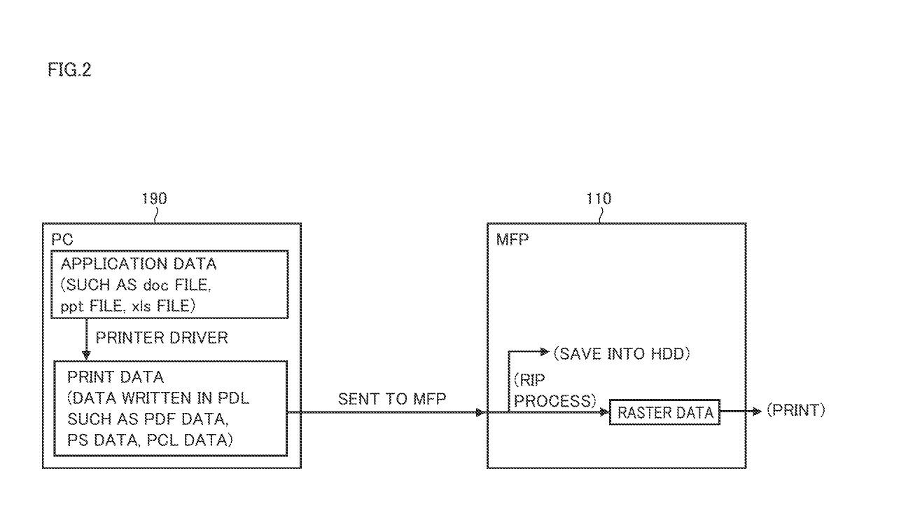

FIG. 2 is a diagram conceptually showing conversion of data formats when printing is done.

Referring to FIG. 2, upon receiving from a user an instruction to print application data of a material to be used in a meeting, CPU 192 of PC 190 converts the application data into print data using a printer driver. The application data is data created, for example, in a file format with an extension such as “.doc,” “.ppt,” or “.xls,” and the print data is data described in a printer language (PDL language) such as “PDF (R),” “Post Script (R),” or “PCL (R).” CPU 192 then transmits the converted print data to MFP 110 which executes printing. CPU 102 of MFP 110 receives the print data and then stores the print data into HDD 101 of MFP 110 as printing data. CPU 102 thereafter converts the print data into raster data through an RIP process and performs printing based on the raster data. After printing, CPU 102 stores the history of the printing as printing history data (FIG. 7), which will be described later, into HDD 101.

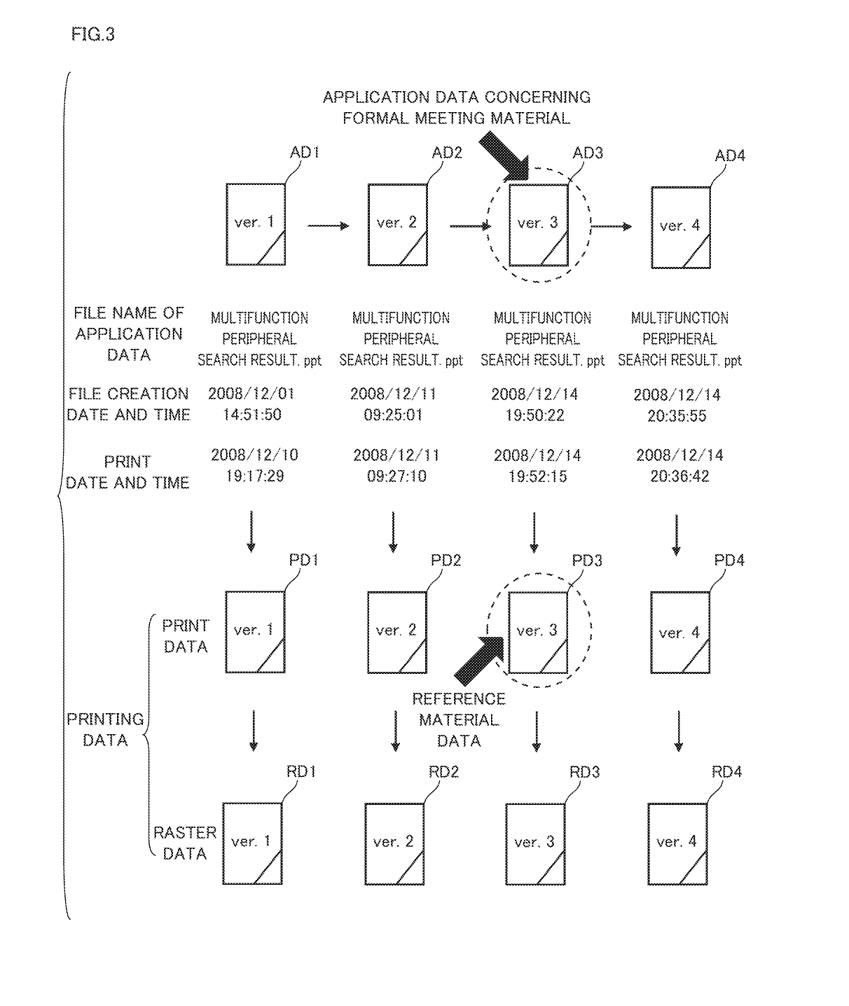

FIG. 3 is a conceptual diagram showing the relation between a material created by a meeting organizer and printing data corresponding to the material.

Referring to FIG. 3, it is assumed that a meeting organizer creates application data AD1 having a file name “multifunction peripheral search result. ppt” as a material to be used in a meeting and intends to distribute this material to participants. In this case, the organizer (or material creator) creates application data AD1 having a file name “multifunction peripheral search result. ppt” at his/her own PC 190 and stores application data AD1 into a location (for example, HDD 101 of MFP 110) from which the participants can execute printing.

For example, upon receiving an instruction to print application data AD1 from the meeting organizer or participant, PC 190 converts the application data into print data PD1 using a printer driver. PC 190 then transmits the converted print data PD1 to MFP 110 which executes printing. Upon receiving print data PD1, MFP 110 stores print data PD1 into HDD 101. MFP 110 thereafter converts print data PD1 into raster data RD1 through an RIP process and performs printing based on raster data RD1. It is noted that MFP 110 may store raster data in place of print data or in addition to print data, into HDD 101. After printing, MFP 110 stores the history of the printing in HDD 101. The printing history includes the file creation date and time of application data AD1 (2008-12-01-14:51:50) and the print date and time thereof (2008-12-10-19:17:29).

When the organizer revises application data AD1 after application data AD1 is printed, application data AD1 stored in HDD 101 of MFP 110 is overwritten with the revised application data AD2 (or the revised application data AD2 is saved in a location different from that of application data AD1). When an instruction to print application data AD2 is received from the organizer (or participant), print data PD2 obtained by converting application data AD2 is automatically stored into HDD 101 together with the file creation date and time of application data AD2 (2008-12-11-09:25:01) and the print date and time thereof (2008-12-11-09:27:10).

When the organizer revises application data AD2 after application data AD2 is printed, application data AD2 stored in HDD 101 of MFP 110 is overwritten with the revised application data AD3 (or the revised application data AD3 is saved in a location different from that of application data AD2). When an instruction to print application data AD3 is received from the organizer (or participant), print data PD3 obtained by converting application data AD3 is automatically stored into HDD 101 together with the file creation date and time of application data AD3 (2008-12-14-19:50:22) and the print date and time thereof (2008-12-14-19:52:15).

When the organizer further revises application data AD3 after application data AD3 is printed, application data AD3 stored in HDD 101 of MFP 110 is overwritten with the revised application data AD4 (or the revised application data AD4 is saved in a location different from that of application data AD3). When an instruction to print application data AD4 is received from the organizer (or participant), print data PD4 obtained by converting application data AD4 is automatically stored into HDD 101 together with the file creation date and time of application data AD4 (2008-12-14-20:35:55) and the print date and time thereof (2008-12-14-20:36:42).

Therefore, when application data is repeatedly revised and the revised application data is printed each time at the MFP, print data PD1 to PD4 each corresponding to each version of application data AD1 to AD4 is automatically stored in MFP 110 together with the file creation date and time and the print date and time for each of application data AD1 to AD4.

Here, the formal meeting material to be actually used in a meeting may be updated (changed) by the organizer from application data AD1 to application data AD3, which is any given version of application data, after application data AD1 is provided in a printable state to the participants. In such a case, it can be assumed that the participants may have printed application data AD1, AD2, or AD4, which is a different version from application data AD3 serving as the formal meeting material.

Then, the material printing system in the present embodiment searches for the printing histories of the participants in HDD 101 of each MFP 110 and obtains the printing history for each participant. Then, the material printing system specifies print data obtained by converting application data that is printed by each participant, and calculates the difference between the print data of each participant and print data PD3 obtained by converting application data AD3. Accordingly, the material printing system grasps the participant who has printed a different version of application data AD1, AD2, or AD4 (the participant who has printed a different version of print data PD1, PD2, or PD4). The material printing system then provides the participant who has printed a different version of application data AD1, AD2, or AD4 with the formal meeting material by printing only the portion corresponding to the difference between print data PD3 and the print data of each participant (that portion of print data PD3 which is different from print data PD1, PD2, or PD4 of the participant).

In the foregoing case, application data AD3 is application data concerning the formal meeting material, that is, application data concerning the meeting material that the meeting organizer is going to actually use in the meeting. Print data PD3 obtained by converting application data AD3 is material data serving as a reference in calculating a difference. Print data equivalent to print data PD3 may be referred to as “reference material data” in the specification of the subject application.

In the specification of the subject application, “a different version of print data” means the old reference material data specified by the meeting information table before updating, or print data obtained by converting application data that has a file name matching the file name of application data corresponding to the current reference material data but has a different file creation date and time.

### [Configuration of MFP]

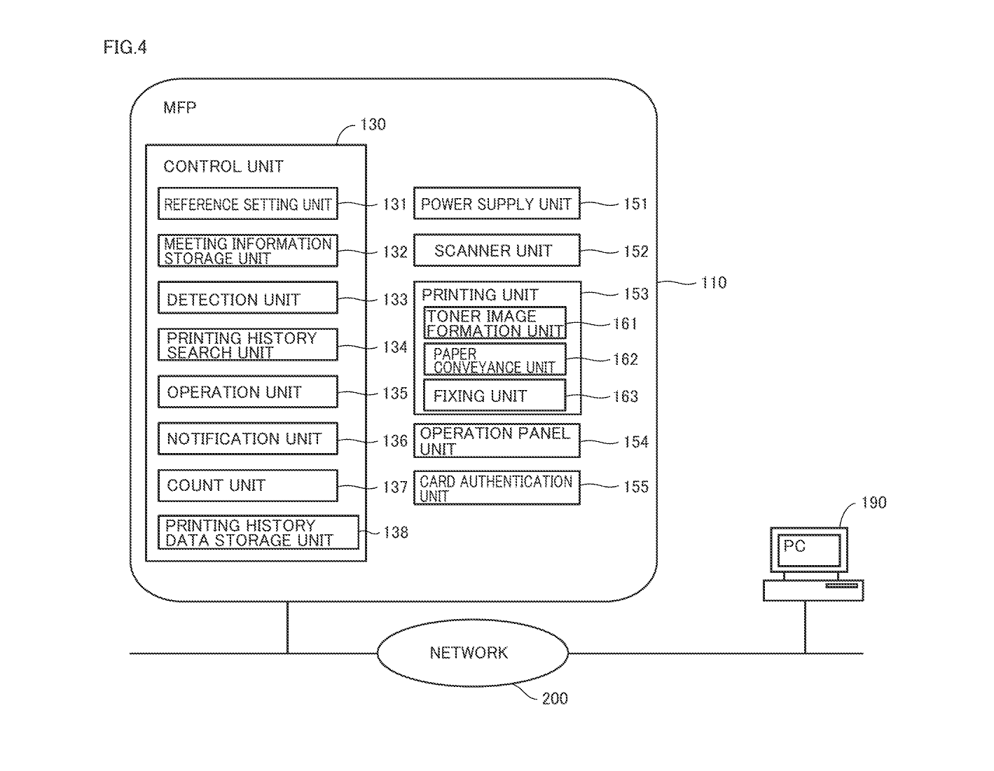

FIG. 4 is a block diagram functionally showing a configuration of MFP 110 in the embodiment of the present invention.

Referring to FIG. 4, MFP 110 includes a control unit 130, a power supply unit 151, a scanner unit 152, a printing unit 153, an operation panel unit 154, and a card authentication unit 155.

Control unit 130 performs sequence control of the entire processing such as scanning, print, transmission, and reception and controls the operation of each unit of MFP 110. Control unit 130 is mainly configured with HDD 101, CPU 102, ROM 103, RAM 104, network controller 105 (FIG. 1), and a circuit for controlling each unit.

Control unit 130 includes, for example, a reference setting unit 131, a meeting information storage unit 132, a detection unit 133, a printing history search unit 134, an operation unit 135, a notification unit 136, a count unit 137, and a printing history data storage unit 138.

Reference setting unit 131 sets any given version of print data as reference material data, among plural versions of print data concerning a meeting (an example of material data), in accordance with an instruction from the user. Meeting information storage unit 132 stores, in the meeting information table (FIG. 5), meeting information indicating the relation among a meeting, reference material data concerning the meeting, and the participants in the meeting. In other words, meeting information storage unit 132 stores information for grasping who takes part in which meeting and which print data is to be used as a material. Detection unit 133 detects whether reference material data concerning a particular meeting is set. Printing history search unit 134 (an example of a history obtaining unit) searches for (obtains) a printing history of print data concerning a particular meeting for a participant in the particular meeting. Operation unit 135 (an example of a calculation unit) calculates the difference between print data printed by a participant in a particular meeting and reference material data concerning the particular meeting (difference between print data) based on the printing history obtained by printing history search unit 134. Notification unit 136 transmits a variety of messages, for example, indicating that a meeting material is updated, to PC 190. Count unit 137 counts the number of sheets printed by printing unit 153. Printing history data storage unit 138 stores printing history data as described later.

The programs or data for implementing these functions are installed in HDD 101 (FIG. 1). These programs or data may be loaded into RAM 104 as necessary so that the programs are executed by CPU 102. Part or all of these functions may be implemented by a processor (a control circuit).

Power supply unit 151 is provided in the casing of MFP 110. Power supply unit 151 is connected to a commercial power supply. Power supply unit 151 supplies power to control unit 130, printing unit 153, and the like, based on the commercial power supply.

Scanner unit 152 performs a scanner function. Scanner unit 152 scans a document placed on a transparent platen using a contact image sensor and reads the document as image data. Scanner unit 152 has an ADF (Automatic Document Feeder) and scans image data using the contact image sensor while successively taking in multiple sheets of a document set on a document tray using the ADF. The scanned image data is converted into an application data format, for example, in control unit 130 and stored, for example, into HDD 101.

Printing unit 153 mainly includes a toner image formation unit 161, a paper conveyance unit 162, and a fixing unit 163. Printing unit 153 forms an image on paper, for example, by electrophotography. Printing unit 153 is configured to combine four colors of images in tandem and form a color image on paper.

Toner image formation unit 161 includes photoconductors for cyan (C), magenta (M), yellow (Y), and black (K), an intermediate transfer belt onto which toner images are transferred from the photoconductors (primary transfer), and a transfer unit for transferring an image from the intermediate transfer belt onto paper (secondary transfer).

Paper conveyance unit 162 is a unit for conveying paper and mainly includes a paper feeding roller, a conveyance roller, and a motor for driving them. Paper conveyance unit 162 feeds paper from a paper feed cassette and discharges paper to a paper output tray through toner image formation unit 161 and fixing unit 163.

Fixing unit 163 has a heating roller and a pressing roller. Fixing unit 163 conveys paper having a toner image sandwiched between the heating roller and the pressing roller, and heats and presses the paper. Fixing unit 163 thus fuses toner adhered on the paper and fixes the toner on paper thereby forming an image on the paper.

Operation panel unit 154 mainly includes a liquid crystal display. The liquid crystal display is formed as a touch panel and can be used for a variety of display and settings. More specifically, the liquid crystal display displays a guide screen or an operation button to the user and accepts an instruction from the user through a touch operation. The liquid crystal display is controlled by control unit 130 for display. When the operation button of operation panel unit 154 is operated by the user, operation panel unit 154 sends an operation signal or a prescribed command corresponding to the operation to control unit 130. In other words, the user can allow MFP 110 to perform a variety of operations by performing operations from operation panel unit 154.

Card authentication unit 155 performs personal authentication using an ID card (authentication card). More specifically, card authentication unit 155 communicates with an ID card held by a user in a contact or noncontact manner to accept entry of the user's ID stored in a storage unit of the ID card and sends the accepted user ID to CPU 102. Card authentication unit 155 mainly has an antenna and a radio circuit for generating a magnetic field for communicating with an ID card, and a circuit for demodulating and decoding information received from the ID card. Card authentication unit 155 may be installed in MFP 110 as shown in FIG. 4 or may be provided in the vicinity of MFP 110 independently from MFP 110 and connected with MFP 110 so as to be able to communicate therewith, for example, through a USB cable.

### [Meeting Information Table and Print Information Table]

The meeting information table and the print information table stored in HDD 101 of MFP 110a will now be described. It is noted that the meeting information table and the print information table may be stored in HDD 101 of any other MFP (MFP 110b or MFP 110c).

FIG. 5 shows an example of the meeting information table stored in HDD 101 of MFP 110a.

Referring to FIG. 5, the meeting information table includes at least one piece of meeting information. In the meeting information table, the items “meeting ID,” “starting date and time,” “organizer ID” (the user ID of an organizer), “participant ID” (the user ID of a participant), “material file name” (material list), and “file creation date and time” are associated with each other for one piece of meeting information in the horizontal direction (row direction) of the table. Of these items, “material file name” means the file name of application data of a material to be used in the meeting. “File creation date and time” means the creation date and time of application data (application data before conversion into print data set as reference material data) corresponding to the reference material data. The reference material data obtained by converting application data of the formal meeting material to be used in the meeting can be specified by the items “material file name” and “file creation date and time.”

It can be understood from the meeting information in FIG. 5 that, for a meeting having a meeting ID “001-00001,” for example, the starting date and time is 10:00 on Dec. 15, 2008, the meeting organizer is the one having a user ID “e15835,” and the meeting participants include the one having a user ID “e15830.” It can be also understood that print data that is obtained by converting application data having a file name “multifunction peripheral search result. ppt” and having a creation date and time of 2008-12-14-19:50:22 is set as reference material data.

For example, when plural versions of print data PD1-PD4 (FIG. 3) having a file name “multifunction peripheral search result. ppt” are stored in HDD 101 of MFP 110, print data PD3 set as the reference material data can be specified by the file creation date and time “2008-12-14-19:50:22.” When no reference material data is set, the item “file creation date and time” is empty. In the vertical direction (column direction) of the table, the meeting information is arranged from the top to the bottom in the order of date and time of holding meetings.

The meeting information excluding the item “file creation date and time” is created, for example, by the meeting organizer accessing HDD 101 of MFP 110a from his/her own PC 190a via network 200 and entering each item. The material to be used in the meeting is also created, for example, by the meeting organizer before the start of the meeting and is saved, for example, in HDD 101 of any one of MFP 110 (or the location in HDD 191 of the meeting organizer's PC 190a that is accessible from an external device connected via network 200). It is noted that the item “file creation date and time” in the meeting information is automatically entered, for example, by CPU 102 of MFP 110a when the meeting organizer sets reference material data as described later.

Information for specifying a meeting, such as a meeting name, may be stored as meeting information in place of a meeting ID, and information for specifying an individual, such as a name, may be stored in place of a user ID of an organizer or participant. Each meeting information may be deleted automatically (without an instruction from the meeting organizer) from the meeting information table immediately after the meeting or after a certain time period has passed since the end of the meeting.

FIG. 6 shows an example of the print information table stored in HDD 101 of MFP 110a.

Referring to FIG. 6, the print information table includes print information in which at least one participant ID and a printing method (print method) are associated with each other. In the horizontal direction (row direction) of the table, the user ID (participant ID) of one user is related with a print method desired by the user. In the vertical direction (column direction) of the table, for example, print information is arranged from the top to the bottom in increasing order of user IDs (participant IDs).

It can be understood from the print information table in FIG. 6 that, for example, a person having a user ID “e03762” wishes printing of the material in full-text print and a person having a user ID “04946” wishes printing of the material in differential print.

The print information table is created, for example, by the administrator of the material printing system entering each item at the time of initial settings of the material printing system (or before the start of the meeting).

### [Printing History Data and ID Information Table]

The printing history data and the ID information table stored in HDD 101 of each MFP 110 will now be described.

FIG. 7 shows an example of the printing history data stored in HDD 101 of MFP 110.

Referring to FIG. 7, the printing history data shows printing histories in a given MFP 110. In the printing history data, the items “printing date and time,” “user who did printing,” “file name,” and “file creation date and time” are associated each other for each printing history in the horizontal direction (row direction) of the table. Among the items arranged in the horizontal direction of the table, “file name” means the file name of application data concerned with the given printing, and “file creation date and time” means the date and time at which application data concerned with the given printing was created (saved). Each printing history is associated with print data (data before the RIP process) or raster data (data after the RIP process) obtained by converting application data during the given printing. Printing histories are arranged from the top to the bottom, for example, in the order of printing date and time in the vertical direction (column direction) of the table.

It can be understood from the printing history data in FIG. 7 that, for example, a user having an ID “e15835” printed application data having a file name “multifunction peripheral search result. ppt” at 19:17:29 on Dec. 10, 2008. It can be also understood that this application data was created at 14:51:50 on Dec. 1, 2008.

Each printing history in the printing history data and print data or raster data are created by CPU 102 of MFP 110 at the time of printing. When the number of printing histories and print data or raster data reaches a certain value (or when a certain time has passed since printing), they are deleted in the order of occurrence. The print data (print data PD3 in FIG. 3) set as reference material data is desirably not deleted since it is used later to calculate the difference.

FIG. 8 shows an example of the ID information table stored in HDD 101 of MFP 110.

Referring to FIG. 8, the ID information table includes the ID of a user who is permitted to use the given MFP 110, the mail address of the user, and the IP address of the PC used by the user. In the ID information table, the items “ID,” “mail address,” and “IP address” are associated with each other for one user in the horizontal direction (row direction) of the table. The ID information table may include only one of “mail address” and “IP address” as long as it includes a contact of a user. The ID information table may include information for specifying an individual, such as a name, in place of a user ID, and may additionally include a password of each user.

The ID information table is used, for example, when MFP 110 notifies each user of a variety of messages. The ID information table is created, for example, by the administrator of the material printing system entering each item at the time of initial settings of the material printing system (or before the start of the meeting).

### [Method of Setting Reference Material Data]

A method of setting reference material data will now be described.

In the present embodiment, it will be described by way of example that print data (print data PD3 in FIG. 3) obtained by converting application data having a material file name “multifunction peripheral search result. ppt” is set as reference material data in a meeting having an ID “001-00001” in the meeting information table shown in FIG. 5.

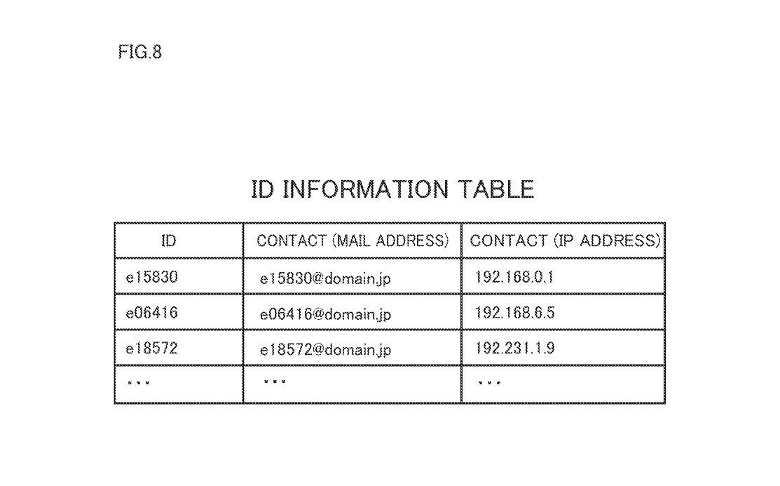

FIG. 9 shows an exemplary printing dialog box appearing on display unit 196 of PC 190a when reference material data is set.

Referring to FIG. 9, application data (application data AD3) named “multifunction peripheral search result. ppt” to be used in the meeting is opened by a user as a meeting organizer at PC 190a. This application data is saved, for example, in HDD 101 of MFP 110.

A printing dialog box 10 (printing execution screen) appears on display unit 196 of PC 190a. Printing dialog box 10 has, for example, a plurality of tabs 11a-11e, an OK button 14, and a cancel button 15. A plurality of tabs 11a-11e are horizontally arranged at the top of printing dialog box 10 in FIG. 9. OK button 14 and cancel button 15 are arranged on the lower right of printing dialog box 10.

When the user presses tab 11e serving as a tab for reference setting, a message “Set as a reference material?” as well as a “YES” button 13a and a “NO” button 13b appear on the right side of printing dialog box 10. A thumbnail 12, for example, of the first page of the opened application data appears on the left side of printing dialog box 10. Thus, CPU 192 of PC 190a (or control unit 130 of MFP 110a) asks the user whether to set the print data (print data PD3) obtained by converting the application data, as reference material data. In the state of initial settings, for example, button 13b is selected.

When the user presses OK button 14 in the state in which “YES” button 13a is selected, control unit 130 of MFP 110a accepts an instruction to print the application data and an instruction to set the print data obtained by converting the application data as reference material data, through CPU 192 of PC 190a, and executes an application data printing process and a reference material data setting process as described later. On the other hand, when the user presses OK button 14 in the state in which “NO” button 13b is selected, control unit 130 of MFP 110a only executes the application data printing process without executing the reference material data setting process. When the user presses cancel button 15, the display of printing dialog box 10 is gone.

Control unit 130 of MFP 110a may perform user authentication with password entry or any other similar method and may accept an instruction to set reference material data only when the user is authenticated.

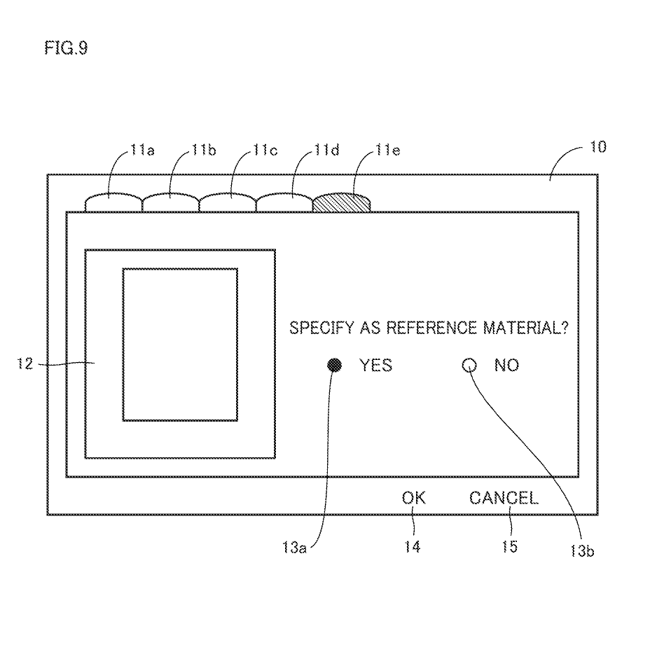

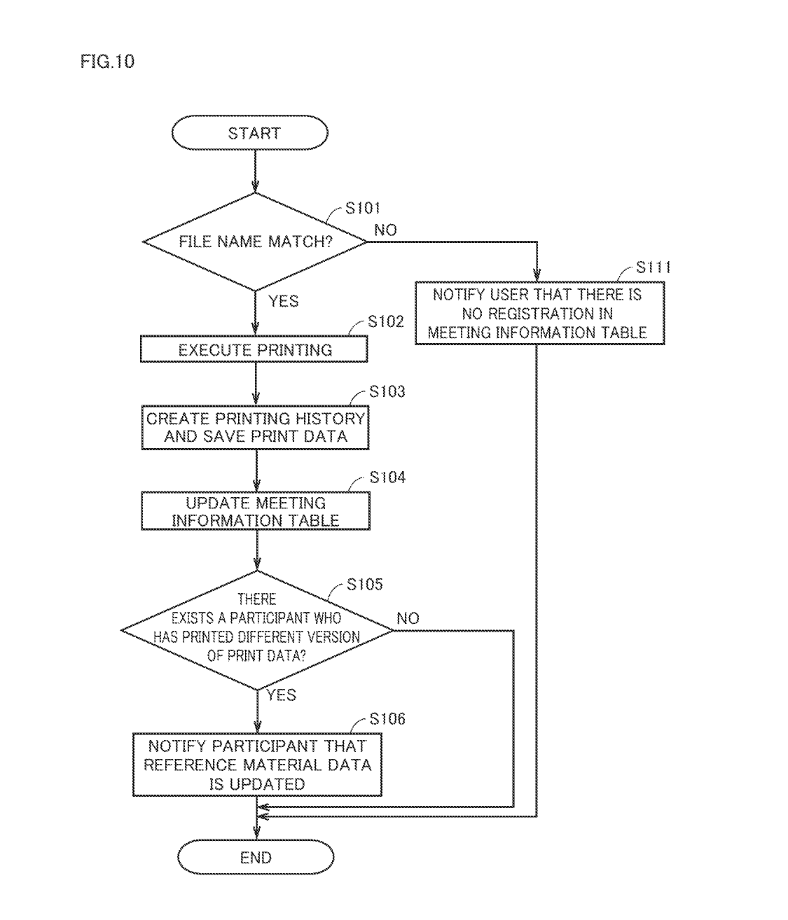

FIG. 10 is a flowchart showing the application data printing process and the reference material data setting process executed by control unit 130 of MFP 110a in the embodiment of the present invention. It is noted that the process according to the flowchart shown in FIG. 10 may be performed by control unit 130 of any other MFP 110 (MFP 110b or 110c) or CPU 192 of PC 190a.

Referring to FIG. 10, control unit 130 of MFP 110a determines whether there exists, in the meeting information table (FIG. 5), meeting information that includes the file name matching the file name (“multifunction peripheral search result. ppt”) of the application data (application data AD3) for which the print instruction is accepted (S101). If there exists, in the meeting information table, meeting information that includes the file name matching the file name of the application data for which the print instruction is accepted (YES in S101), control unit 130 executes printing of the application data (S102). Control unit 130 then creates a printing history in the printing history data (FIG. 7) and saves the print data (print data PD3) obtained by converting the application data during printing, into HDD 101 (S103). Control unit 130 then updates the meeting information table by entering the creation date and time of the printed application data (2008-12-14-19:50:22) into the item “file creation date and time” in the meeting information that includes the file name matching the file name of the application data for which the print instruction is accepted (S104). Accordingly, the print data (PD3) obtained by converting the application data (AD3) during printing is set as reference material data. The print data set as reference material data is specified by the file name (“multifunction peripheral search result. ppt”) of the application data before conversion and by the file creation date and time (2008-12-14-19:50:22). Control unit 130 then obtains, from the printing history data (FIG. 7) in HDD 101 of each MFP 110a-110c, the printing history of the file name matching the file name of the application data for a participant in the meeting concerning the updated meeting information. Then, control unit 130 determines whether there exists a participant who has printed a different version of print data (print data PD1, PD2, or PD4), based on the obtained printing history (S105). If there exists a participant who has printed a different version of print data (YES in S105), control unit 130 notifies that participant that the meeting material (reference material data) is updated, based on the ID information table (FIG. 8) (S106). The process then ends. If there exists no participant who has printed a different version of print data (NO in S105), control unit 130 ends the process.

If there exists, in the meeting information table, no meeting information that includes the file name matching the file name of the application data for which the print instruction is accepted, in S101 (NO in S101), it means that it is unknown which meeting the print data to be set as reference material data is concerned with. In this case, control unit 130 notifies the user that the file name of the application data for which the print instruction is accepted is not registered in the meeting information table (S111). The process then ends.

FIG. 11 shows an exemplary dialog box appearing on the display unit of the PC of the meeting organizer in step S111 in FIG. 10.

Referring to FIG. 11, when the user as a meeting organizer is going to set, as reference material data, the print data obtained by converting application data having a file name not registered in the meeting information list, a dialog box 16 including a message “Not registered in the meeting material list” and an OK button 21 appears on display unit 196 of PC 190a to notify the user that the print data cannot be set as reference material data. Dialog box 16 is displayed until OK button 21 is pressed. In this case, the user can set reference material data by entering the item “material file name” in the meeting information table (FIG. 5).

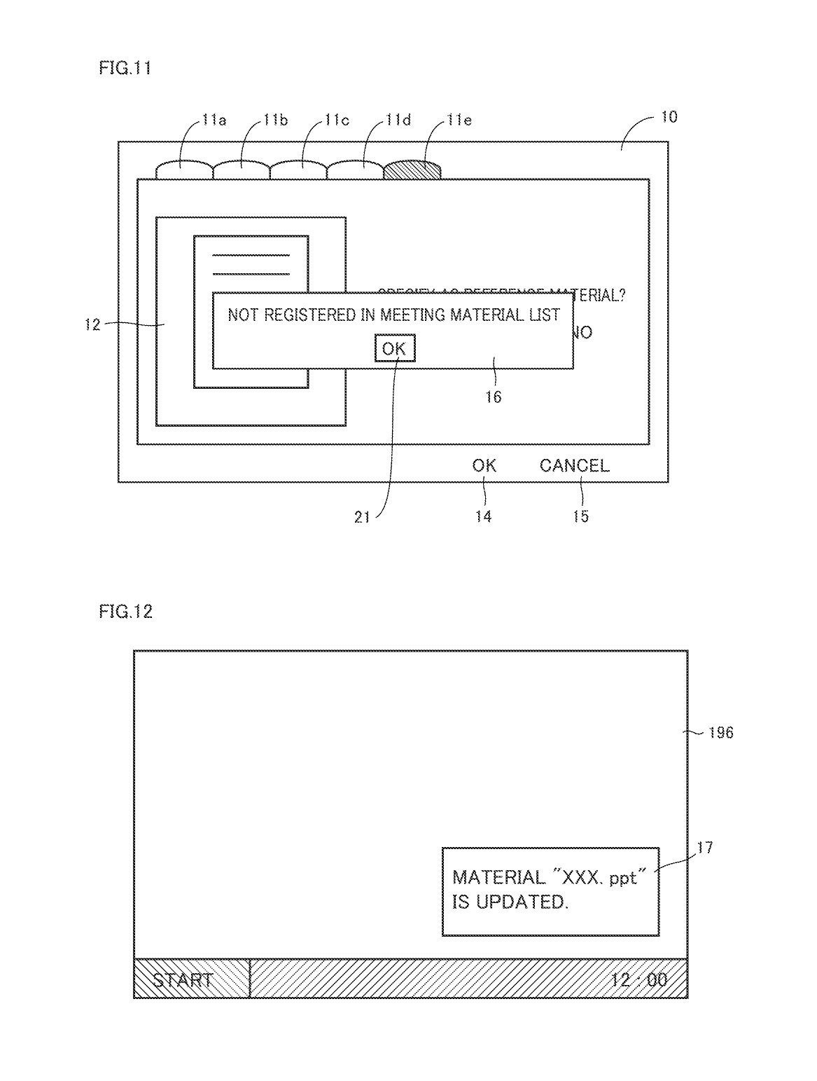

FIG. 12 shows an exemplary dialog box appearing on the display unit of the PC of the meeting participant in step S106 in FIG. 10.

Referring to FIG. 12, when the reference material data of a meeting is updated, display unit 196 of PC 190b of the meeting participant who has printed a different version of print data displays a message box 17 including a message “Material ‘xxx. ppt’ is updated” for a certain period of time (‘xxx. ppt’ is, in this case, ‘multifunction peripheral search result. ppt’), thereby prompting the participant to print the updated reference material data. An email may be sent to the meeting participant who has printed a different version of print data to give a notification that the reference material data is updated.

### [Print Data Printing Process]

A meeting participant usually accesses HDD 101 of MFP 110a (or HDD 191 of PC 190a of a meeting organizer) via network 200 from his/her own PC 190b and obtains a meeting material by printing application data (application data corresponding to reference material data) of a formal meeting material to be actually used in a meeting. Otherwise, a meeting participant may refer to the printing history data saved in HDD 101 of MFP 110a and obtain a meeting material by selecting the print data assumed to be set as reference material data, from the printing history data, and printing the selected print data. However, in this case, the meeting participant may erroneously print a different version of print data (for example, print data PD4 in FIG. 3). In order to prevent such a situation, control unit 130 of MFP 110a may perform the print data printing process according to the flowchart shown below.

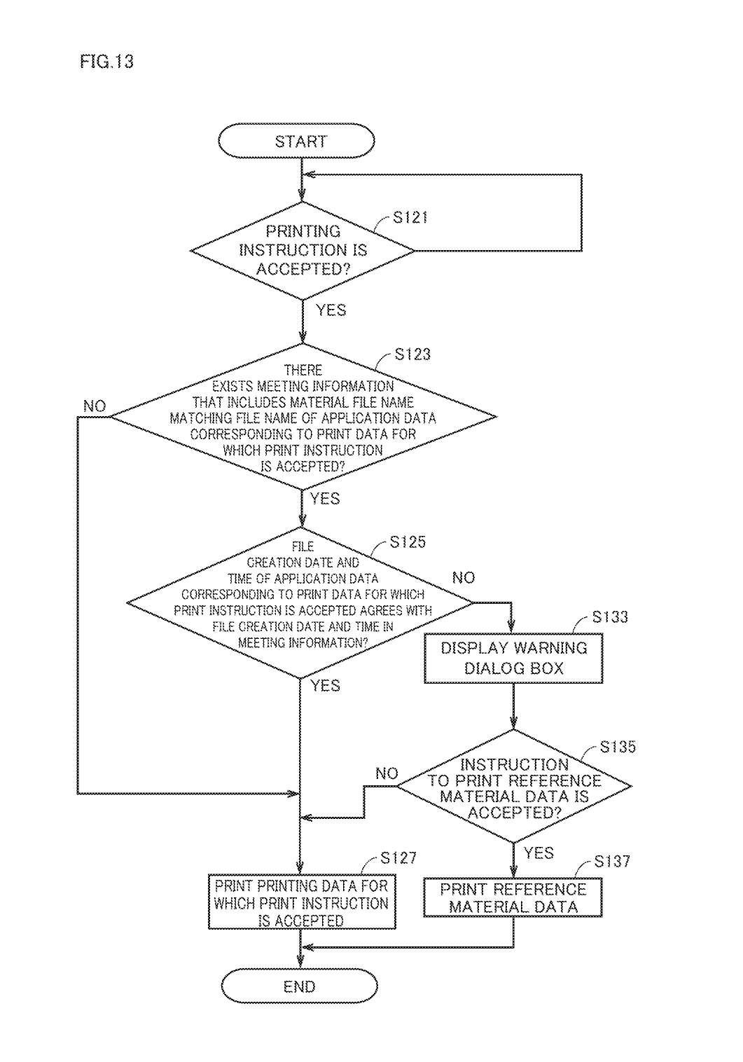

FIG. 13 is a flowchart of the print data printing process executed by control unit 130 of MFP 110a.

Referring to FIG. 13, when a print instruction for print data is accepted from a user as a meeting participant (YES in S121), control unit 130 of MFP 110 determines whether there exists, in the meeting information table (FIG. 5), meeting information that includes the material file name matching the file name of the application data corresponding to the print data for which the print instruction is accepted (S123). If there exists meeting information that includes the matching material file name (YES in S123), control unit 130 determines whether the file creation date and time of the application data corresponding to the print data for which the print instruction is accepted agrees with the file creation date and time in the meeting information having the matching file name (S125). If the file creation dates and times agree (YES in S125), it means that the print data that the user is going to print is the file set as a reference. In this case, control unit 130 prints the print data for which the print instruction is accepted (S127). The process then ends.

If there exists no meeting information that includes the matching material file name in S123 (NO in S123), it means that the print data that the user is going to print is irrelevant with the meeting material. In this case, control unit 130 prints the print data for which the print instruction is accepted (S127). The process then ends.

If the file creation date and time in the meeting information does not agree in step S125 (NO in S125), it means that the print data that the user is going to print is a different version of print data. In this case, control unit 130 displays a warning dialog box on display unit 196 of PC 190 (S133) and asks the user whether to correctly print the reference material data (S135). If an instruction to print the reference material data is accepted (YES in S135), control unit 130 prints the reference material data (S137). The process then ends. If an instruction to print the reference material data is not accepted (NO in S135), it means that the user wishes to print a different version of print data. In this case, control unit 130 prints the print data for which the print instruction is accepted (S127). The process then ends.

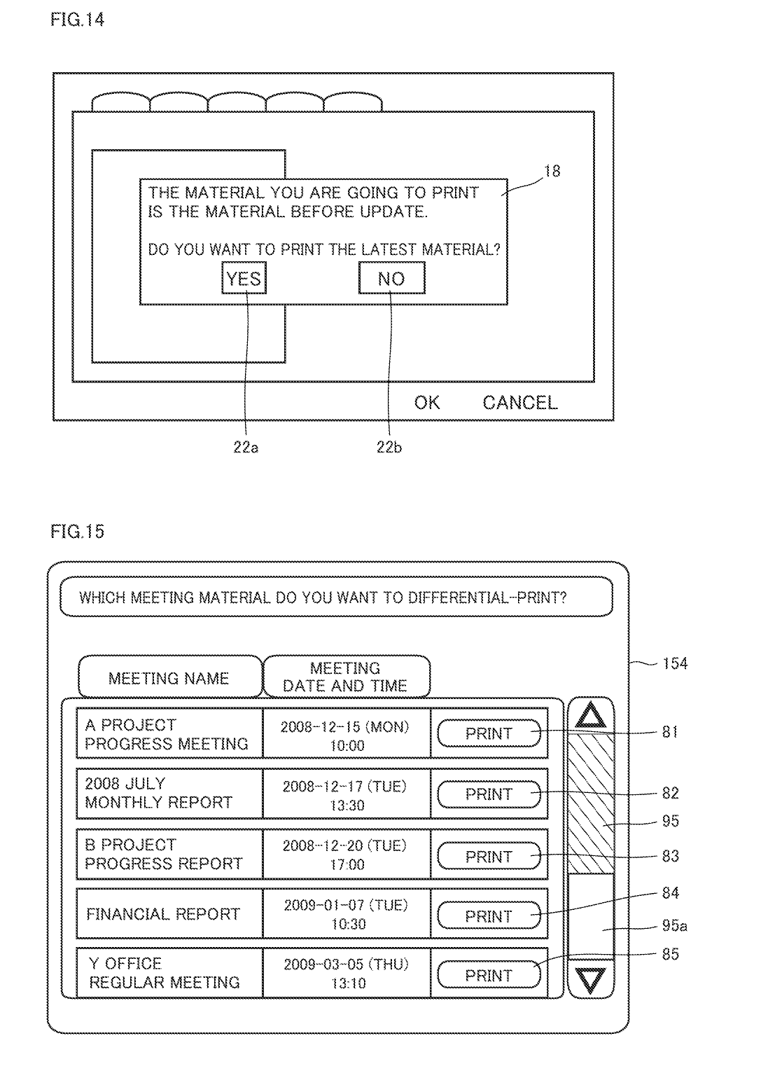

FIG. 14 shows an example of the warning dialog box displayed in step S133 in FIG. 13.

Referring to FIG. 14, display unit 196 of PC 190b of the meeting participant displays a dialog box 18 (the warning dialog box) including a message “The material you are going to print is the material before update. Do you want to print the latest material?” as well as a “YES” button 22a and a “NO” button 22b. Accordingly, PC 190b notifies the meeting participant that the print data the user is going to print is not the reference material data, and also asks the meeting participant whether to print the reference material data.

If the user presses “YES” button 22a, control unit 130 of MFP 110a accepts an instruction to print the reference material data through PC 190b and then prints the reference material data. On the other hand, if the user presses “NO” button 22b, control unit 130 of MFP 110a prints the print data for which the print instruction is accepted.

### [Differential Printing Method for Meeting Participant]

A differential printing method for a meeting participant will now be described.

For example, control unit 130 of MFP 110a installed in meeting room A shown in FIG. 1 automatically executes the differential printing process at the starting date and time of a meeting in meeting room A that is included in the meeting information, or at a certain time before the starting date and time. In this case, an instruction of differential printing from a user is not necessary.

Control unit 130 may execute the differential printing process when an instruction of differential printing is accepted from a user such as a meeting organizer, rather than automatically executing the differential printing process in accordance with the time. In this case, the instruction from a user may be accepted through operation panel unit 154 of MFP 110 as shown in FIG. 15.

FIG. 15 shows an exemplary screen appearing on operation panel unit 154 of MFP 110 when a meeting organizer is going to print a material to be distributed to meeting participants.

Referring to FIG. 15, for example, when a user as a meeting organizer presses a differential printing button displayed on operation panel unit 154, control unit 130 of MFP 110a allows operation panel unit 154 to display a message “Which meeting material do you want to differential-print?” to ask the user to select a meeting for which differential printing is to be executed. The meeting information included in the meeting information table is displayed together with the above-noted message on operation panel unit 154. Each of the displayed meeting information includes, for example, a meeting name and a date and time of a meeting. The displayed meeting information is associated with PRINT buttons 81-85 for executing printing. In FIG. 15, since there are too much meeting information to be displayed in a single screen, the display region can be shifted by moving a knob 95a of a scroll bar 95 up and down. When the user presses any one of PRINT buttons 81-85, control unit 130 of MFP 110a executes the differential printing process as described below for the meeting information corresponding to the pressed PRINT button.

In a case other than that show in FIG. 15, the instruction of differential printing may be accepted through PC 190a of a meeting organizer, for example. In addition, control unit 130 may perform user authentication with password entry or any other similar method and may accept the instruction of differential printing only when the user is authenticated.

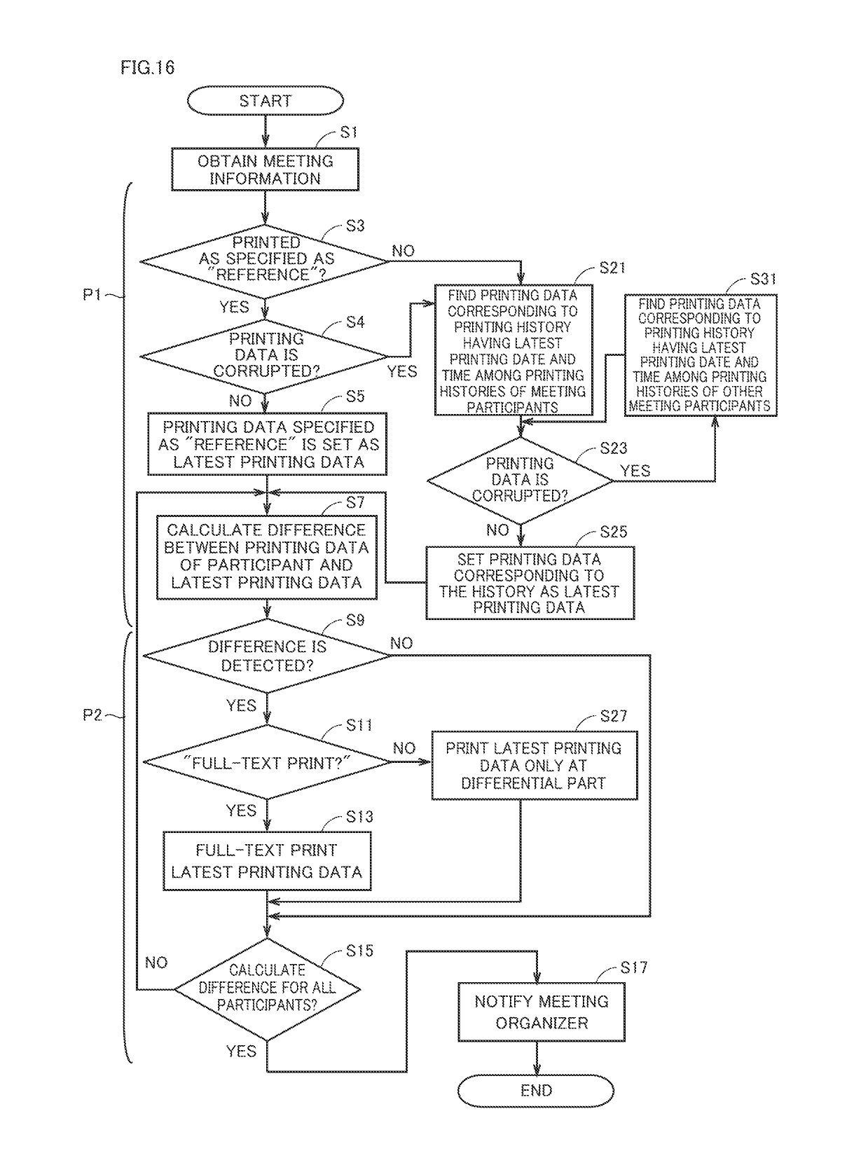

FIG. 16 is a flowchart showing the differential printing process executed by control unit 130 of MFP 110a in the embodiment of the present invention. It is noted that the differential printing process shown in FIG. 16 may be executed by control unit 130 of any other MFP 110 (MFP 110b or 110c) or CPU 192 of PC 190. The differential printing process shown in FIG. 16 also includes a process executed when full-text printing is performed without performing differential printing at the participant's wish.

Referring to FIG. 16, this flowchart mainly includes a process P1 (steps S1-S7), which is a process of calculating the difference between printing data of each participant and printing data (hereinafter also referred to as the latest printing data) corresponding to a formal meeting material to be actually used in a meeting, and a process P2 (steps S9-S17), which is a process of printing the latest printing data for the participant who has printed printing data of a version different from the latest printing data. In FIG. 16, the printing data typically means print data but may mean raster data.

Control unit 130 of MFP 110a obtains the meeting information concerning a meeting to be held from now on, from the meeting information table (FIG. 5) stored in HDD 101 (S1). Control unit 130 then determines whether reference material data is set in the meeting information, based on the obtained meeting information (whether the printing data concerned with the meeting information has been printed as specified as “reference”) (S3). This determination is made based on whether the item “file creation date and time” in the meeting information is entered. If reference material data is set (YES in S3), control unit 130 determines whether the printing data set as reference material data is corrupted (S4). This determination is made, for example, based on whether the printing history corresponding to the reference material data and the reference material data exist in HDD 101. If the printing history corresponding to the reference material data and the reference material data exist in HDD 101, it is determined that the printing data is not corrupted. If the printing history corresponding to the reference material data or the reference material data has already been deleted from HDD 101, it is determined that the printing data is corrupted. If the printing data is not corrupted (NO in S4), control unit 130 determines that the reference material data (the printing data specified as “reference”) is the latest printing data (S5), and then proceeds to step S7.

If it is determined in step S3 that the reference material data is not set (NO in S3) or if it is determined in step S4 that the reference material data is corrupted (YES in S4), the reference material data is not available. In this case, control unit 130 obtains, from the printing history data stored in HDD 101 of each MFP 110, the printing histories of the file name matching the material file name of the obtained meeting information for all the participants in the meeting to be held from now on (searches for and refers to the printing history for each participant). Control unit 130 then finds printing data corresponding to the printing history having the latest printing date and time from the obtained printing histories for all the participants (S21). Then, control unit 130 determines whether the found printing data is corrupted (S23). This determination is made similarly to step S4. If the printing data is not corrupted (NO in S23), control unit 130 determines that the printing data corresponding to the printing history having the latest printing date and time is the latest printing data (S25), and then proceeds to step S7. If the printing data is corrupted in step S23 (YES in S23), printing data corresponding to the printing history having the latest printing date and time is found from the obtained (other) printing histories for all the participants, excluding the printing history corresponding to the corrupted printing data (S31). The process then proceeds to step S23.

In step S7, (if no printing history has been obtained yet) control unit 130 obtains, from the printing history data stored in HDD 101 of each MFP 110, the printing histories of the file name matching the material file name in the meeting information for all the participants of the meeting to be held from now on, based on the obtained meeting information (searches for a printing history for each participant). Control unit 130 then calculates the difference between the latest printing data and the printing data corresponding to the printing history for one of the participants from which the difference has not yet been calculated (the printing data corresponding to the printing history having the latest printing date and time, for example, if there are a plurality of printing histories for that participant), based on the obtained printing histories (S7), and then determines whether a difference is detected (S9). If a difference is detected (YES in S9), it means that the participant has the meeting material obtained by printing the printing data of a version different from that of the latest printing data. In this case, control unit 130 determines whether the printing method for the participant is full-text print, with reference to the print information table (FIG. 6) (S11). If the printing method for the participant is full-text print (YES in S11), control unit 130 allows printing unit 153 to full-text print the latest printing data (S13), and then proceeds to step S15. On the other hand, if the printing method for the participant is differential print in step S11 (NO in S11), control unit 130 allows printing unit 153 to print the latest printing data only at the differential part (the differential part in the latest printing data) (S27), and then proceeds to step S15. If no printing method is included for the participant in the print information table, control unit 130 may perform either full-text printing or differential printing. The differential part printed in step S27 may be either sentence by sentence or by page by page.

If no difference is detected in step S9 (NO in S9), it means that the participant has the meeting material obtained by printing the latest printing data. In this case, it is unnecessary to do printing again, and therefore, control unit 130 proceeds to step S15.

In step S15, control unit 130 determines whether the difference has been calculated for all the participants in the meeting (whether the calculation is repeated for all the participants). If the difference is not calculated for all the participants (NO in S15), control unit 130 returns to step S7 and calculates the difference for another participant from which the difference has not yet been calculated. If the difference is calculated for all the participants (YES in S15), control unit 130 notifies the meeting organizer of the participant from which the difference is detected (S17). The process then ends. It is noted that step S17 may be omitted if there is no participant from which the difference is detected.

Here, the arrow D in FIG. 1 conceptually shows that MFP 110a obtains (searches for) the printing histories of the file name matching the material file name of meeting information for all the participants in a meeting, for example, in step S7 in FIG. 16. Control unit 130 of MFP 110a searches the printing history data stored in HDD 101 of each MFP 110 connected to network 200, based on the item “participant ID” of the meeting information, and obtains the printing history for each participant.

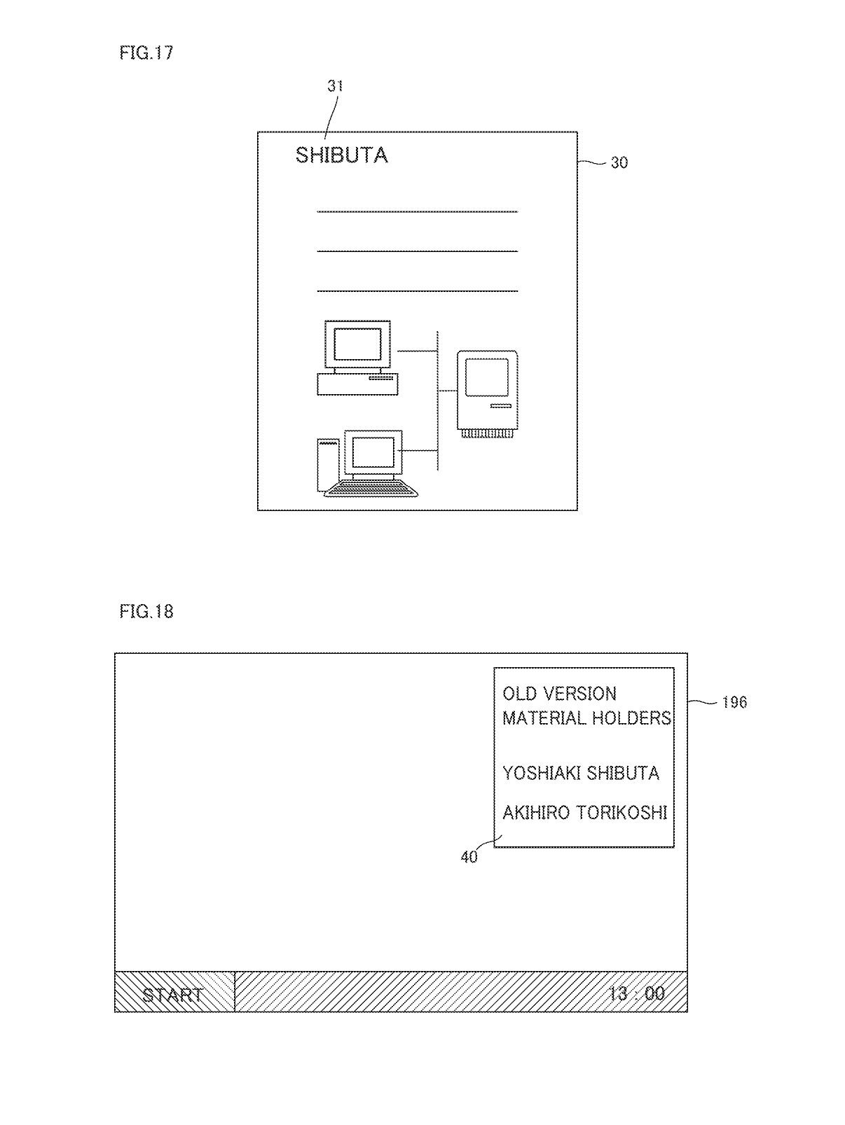

FIG. 17 shows an exemplary meeting material in which printing data is printed.

Referring to FIG. 17, a printout 30 (meeting material) in which printing data to be used in a meeting is printed has a participant name 31 printed thereon to indicate the owner of the printout. Accordingly, it can be easily grasped which participant printout 30 belongs to.

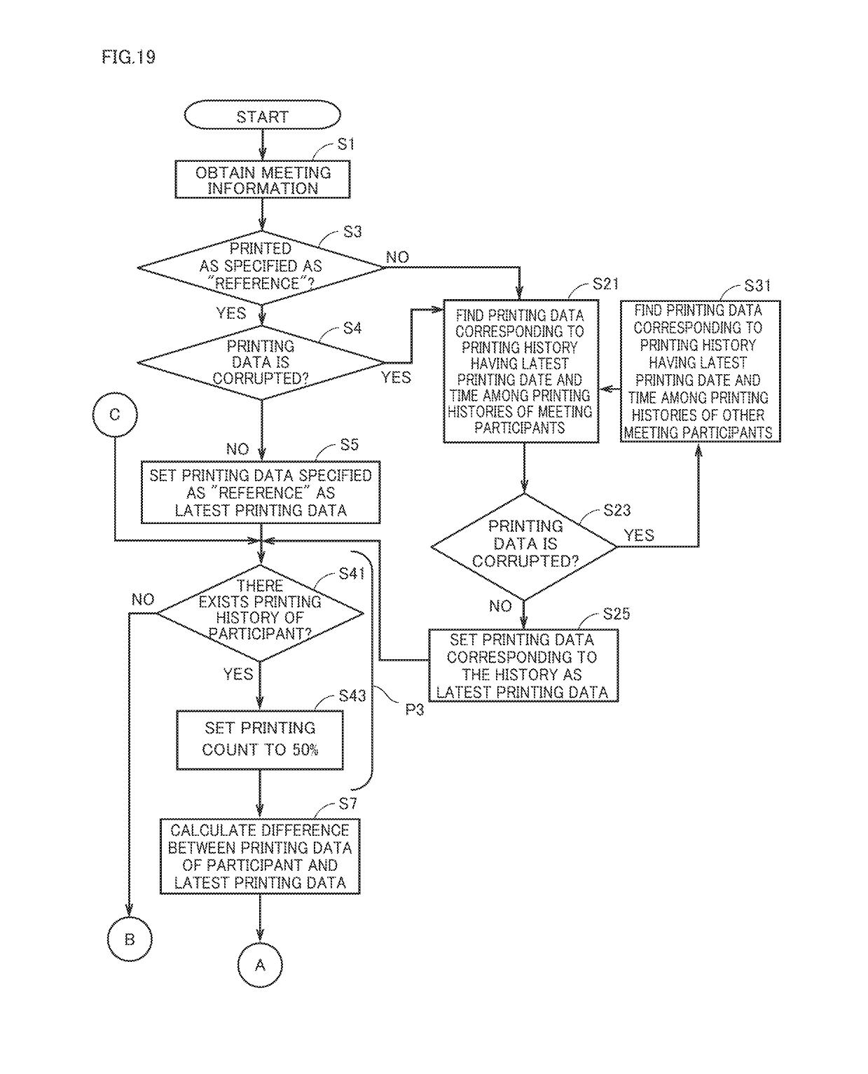

FIG. 18 shows exemplary display of display unit 196 of PC 190a when a notification of a participant having a difference detected is given in step S17 in FIG. 16.

Referring to FIG. 18, if there is a participant from which a difference is detected in step S9 in FIG. 16, control unit 130 (or CPU 192 of PC 190a) may display a list 40 including the detected participant's name (a list of old version material holders) on display unit 196 of PC 190a of the meeting organizer. This can notify the meeting organizer of a participant to which the meeting material in which the latest printing data is printed should be distributed. The notification shown in FIG. 18 may be given at regular time intervals. In place of the notification shown in FIG. 18, emails may be sent to meeting participants to give notification of a participant to which the meeting material in which the latest printing data is printed should be distributed.

### [Modification of Differential Printing]

A modification of the differential printing method for a meeting participant will now be described.

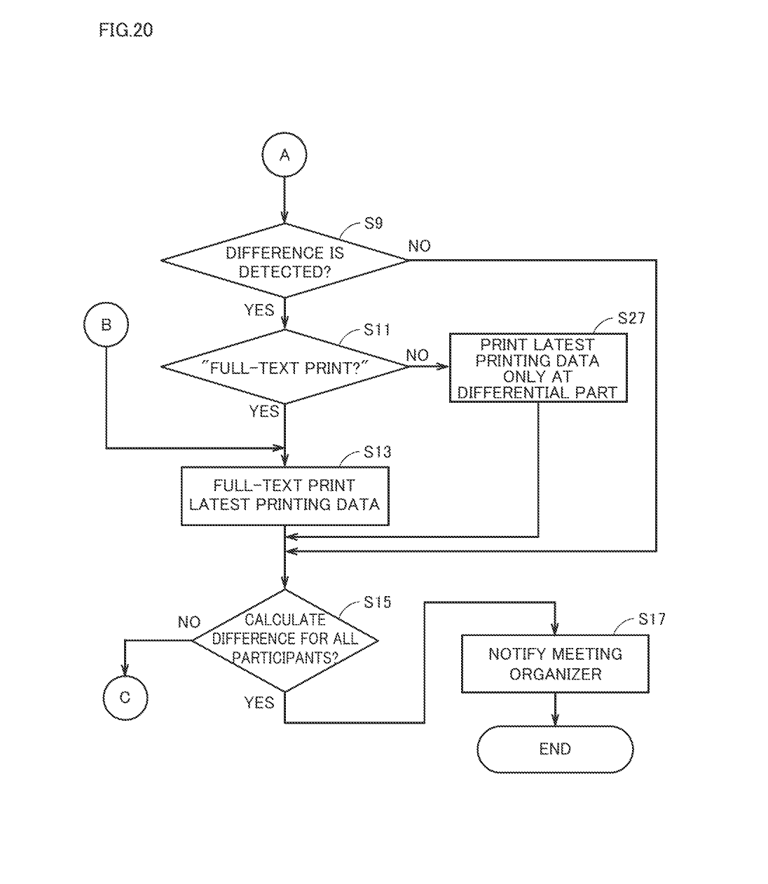

FIG. 19 and FIG. 20 show a flowchart showing a modification of the differential printing process executed by control unit 130 of MFP 110a in the embodiment of the present invention.

Referring to FIG. 19 and FIG. 20, this flowchart mainly differs from the flowchart shown in FIG. 16 in that a process P3, which is a process of counting the number of printed sheets of printing data, is added. In this modification, the number of printed sheets is counted in different ways between the participant who has not printed the meeting material at all and the participant who has printed the printing data of a version different from that of the latest printing data.

Control unit 130 executes the processing similar to the processing illustrated in the flowchart shown in FIG. 16, starting from step S1 shown in FIG. 16. Then, after the latest printing data is determined in step S5 or step S25, or if the difference is not calculated for all the participants in step S15 (NO in S15), the process proceeds to step S41.

In step S41, (if no printing history has been obtained yet) control unit 130 obtains, from the printing history data stored in HDD 101 of each MFP 110, the printing histories of the file name matching the material file name of the meeting information for all the participants in the meeting to be held from now on, based on the obtained meeting information. Control unit 130 then determines, based on the obtained printing histories, whether the printing history of the file name matching the material file name of the meeting information is included in the printing histories of one of the participants for which the difference has not yet been calculated (S41). If the printing history of the matching file name is included (YES in S41), it means that the participant has already printed the meeting material (whether it is reference material data or not). In this case, in step S13 or step S27, control unit 130 sets count unit 137 (FIG. 4) such that the printing counting method in printing for that participant is different from the usual counting method (for example, such that the count is 50% (half) of the normal count) (S43). Thereafter, control unit 130 performs the processing similar to the processing following step S7 shown in FIG. 16.

On the other hand, if the printing history of the printing data concerning the meeting to be held from now on is not included (NO in S41), it means that the participant has not printed the meeting material at all in the past. In this case, control unit 130 proceeds to step S13 shown in FIG. 20 and full-text prints the latest printing data (S13). In this case, the setting of count unit 137 is not changed, and the printing counting method in the full-text printing remains as usual (full count). Thereafter, control unit 130 performs the processing similar to the processing following step S15 shown in FIG. 16.

### EFFECT OF EMBODIMENT

The foregoing embodiment provides a convenient material printing system responsive to actual meeting materials, a material printing apparatus, and a program for controlling the material printing system.

According to the foregoing embodiment, the difference between printing data set as reference material data by a meeting organizer and printing data printed by each participant is calculated based on the printing history of each participant, and differential data corresponding to the calculated difference is printed. Accordingly, the MFP can eliminate a difference between materials held by the participants only by comparing the printing histories of the participants, without configuring any complicated system. As a result, the convenience of the material printing system and the MFP can be improved.

When the reference material data is updated, the meeting participant who has printed a different version of print data is notified that the reference material data is updated, so that the meeting participant who has printed a different version of printing data is prompted to print the updated reference material data.

When a meeting participant is going to print a different version of print data, the participant is notified that the print data is not reference material data, thereby preventing erroneous printing of a different version of print data. Furthermore, the participant can be provided with reference material data.

If a difference is calculated, the meeting organizer is notified of the meeting participant having the printing history from which the difference is calculated. Therefore, the meeting organizer can be notified of the participant who has not yet obtained the material in which the latest printing data is printed.

When reference material data is not set or when reference material data is corrupted, the printing data having the latest printing date and time can be set as the latest printing data, among printing data printed by meeting participants. Therefore, even when reference material data cannot be printed, the printing data assumed as the reference material data can be printed instead.

Furthermore, the number of printed sheets is counted in different ways between when the latest printing data is printed for the participant who has printed a different version of print data and when the material is printed for the participant who has not printed the material at all. Therefore, the charges based on the number of printed sheets are varied between those participants.

### [Others]

In the foregoing embodiment, the material printing system has the configuration shown in FIG. 1. However, the material printing system may be configured arbitrarily. For example, the number of MFPs and PCs connected to the network is not limited. A meeting management server connected to MFP 110a via a network may perform the process executed by the control unit of MFP 110a as described above.

In the foregoing embodiment, the printing data of the material to be used in a meeting is saved in HDD 101 of MFP 110a. However, the printing data of the material to be used in a meeting may be saved in any location. For example, it may be saved in HDD 101 of MFP 110b or MFP 110c, or may be saved in HDD 191 of PC 190, or may be saved in a recording medium such as a USB memory connected to PC 190 or MFP 110.

In the foregoing embodiment, the program for the material printing process is saved in HDD 101 of MFP 110a. However, the program for the material printing process may be saved in any location. For example, it may be saved in HDD 101 of MFP 110b or MFP 110c, or may be saved in HDD 191 of PC 190, or may be saved in a recording medium such as a USB memory connected to PC 190 or MFP 110.

In the foregoing embodiment, the meeting information table is saved in HDD 101 of MFP 110a. However, the meeting information table may be saved in any location. For example, the meeting information table may be saved in HDD 101 of MFP 110b or MFP 110c, or may be saved in HDD 191 of PC 190, or may be saved in a recording medium such as a USB memory connected to PC 190 or MFP 110. The number of pieces of information included in the meeting information table is not limited.

The printing data set as reference material data may be raster data in place of print data. In this case, the difference between raster data is calculated. In place of printing data, application data may be set as reference material data, and the difference between application data may be calculated.

The processing in the foregoing embodiment may be performed by software or using a hardware circuit.

A program executing the processing in the foregoing embodiment may be provided. A recording medium encoded with the program, such as a CD-ROM, a flexible disk, a hard disk, a ROM, a RAM, or a memory card, may be provided to users. The program is executed by a computer such as a CPU. The program may be downloaded to the apparatus over a communication circuit such as the Internet.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A material printing system comprising:
a first reference setting unit for setting any given version of material data as reference material data, among plural versions of material data concerning a particular meeting, in accordance with an instruction from a user;
a history obtaining unit for obtaining a printing history of material data concerning said particular meeting for a participant in said particular meeting;
a calculation unit for calculating a difference between material data printed by a participant in said particular meeting and said reference material data concerning said particular meeting, based on the printing history obtained by said history obtaining unit; and
a printing unit for printing differential data corresponding to said difference.

2. The material printing system according to claim 1, further comprising a meeting information storage unit for storing meeting information showing a relation among a meeting, reference material data concerning said meeting, and a participant in said meeting.

3. The material printing system according to claim 1, further comprising an update notification unit for, if the reference material data is updated from one version of material data to another version of material data, notifying a participant in said particular meeting who has printed said one version of material data that the reference material data is updated.

4. The material printing system according to claim 1, further comprising a non-reference notification unit for, if a participant in said particular meeting is going to print a version of material data not set as reference material data, among plural versions of material data concerning said particular meeting, notifying the participant that the material data that the participant is going to print is not reference material data.

5. The material printing system according to claim 4, wherein if notification is given by said non-reference notification unit, said printing unit prints reference material data for the participant in said particular meeting who is going to print a version of material data not set as reference material data.

6. The material printing system according to claim 1, further comprising a user notification unit for, if said difference is calculated by said calculation unit, notifying said user of a participant in said particular meeting who has a printing history from which said difference is calculated.

7. The material printing system according to claim 6, wherein notification is given by said user notification unit at regular time intervals.

8. The material printing system according to claim 1, further comprising, in at least one of the following cases: reference material data concerning a particular meeting is not set by said first reference setting unit; and reference material data concerning said particular meeting is corrupted, a second reference setting unit for setting material data having a latest date and time as reference material data concerning said particular meeting, among material data printed by all participants in said particular meeting, based on the printing history obtained by said history obtaining unit.

9. The material printing system according to claim 1, further comprising a count unit for counting a number of printed sheets in said printing unit, wherein said count unit makes a count in different ways between when at least part of reference material data is printed for a participant who has printed material data concerning said particular meeting and when reference material data is printed for a participant who has not printed material data concerning said particular meeting at all, based on the printing history obtained by said history obtaining unit.

10. A material printing apparatus comprising:
a first reference setting unit for setting any given version of material data as reference material data, among plural versions of material data concerning a particular meeting, in accordance with an instruction from a user;
a history obtaining unit for obtaining a printing history of material data concerning said particular meeting for a participant in said particular meeting;
a calculation unit for calculating a difference between material data printed by a participant in said particular meeting and said reference material data concerning said particular meeting, based on the printing history obtained by said history obtaining unit; and
a printing unit for printing differential data corresponding to said difference.

11. A non-transitory computer readable medium storing a control program for a material printing system, the program causing a computer to execute processing comprising the steps of:
setting any given version of material data as reference material data, among plural versions of material data concerning a particular meeting, in accordance with an instruction from a user;
obtaining a printing history of material data concerning said particular meeting for a participant in said particular meeting;
calculating a difference between material data printed by a participant in said particular meeting and said reference material data concerning said particular meeting, based on the printing history obtained in said step of obtaining a printing history; and
printing differential data corresponding to said difference.
